(19) United States
(12) Patent Application Publication
(10) Pub. No.: US 2025/0018866 A1
(43) Pub. Date: Jan. 16, 2025

(54) VEHICULAR VISION SYSTEM WITH INTERIOR MIRROR DISPLAY

(71) Applicant: Magna Mirrors of America, Inc., Holland, MI (US)

(72) Inventors: Christopher R. Koetje, Zeeland, MI (US); Christopher L. Long, Big Rapids, MI (US); Adan Pantoja-Parra, Grand Rapids, MI (US); Maxwell E. Ziegler, Grand Rapids, MI (US); Austin T. Buerkle, Grand Rapids, MI (US)

(21) Appl. No.: 18/769,793

(22) Filed: Jul. 11, 2024

Related U.S. Application Data
(60) Provisional application No. 63/580,002, filed on Sep. 1, 2023.
(60) Provisional application No. 63/513,151, filed on Jul. 12, 2023.

(51) Int. Cl. B60R 1/28; B60R 1/00; B60R 1/04; B60R 1/12; B60R 1/24; B60R 1/25; B60R 1/26; B60R 1/29; G06F 3/01

(52) U.S. Cl. CPC B60R 1/28; B60R 1/008; B60R 1/04; B60R 1/24; B60R 1/25; B60R 1/26; B60R 1/29; G06F 3/013; B60R 2001/1253; B60R 2001/1284; B60R 2300/105; B60R 2300/303; B60R 2300/306; B60R 2300/607; B60R 2300/8026; B60R 2300/8046; B60R 2300/8066

(57) ABSTRACT

A vehicular vision system includes a plurality of cameras disposed at a vehicle, a multiplexor operable to aggregate the image data from the cameras into aggregated image data, and an interior rearview mirror assembly disposed at the vehicle remote from the multiplexor. The interior rearview mirror assembly includes a mirror head adjustably disposed at a mounting base configured to attach at an interior portion of the vehicle. The mirror head includes a mirror casing and a mirror reflective element. The interior rearview mirror assembly includes an image processor for processing image data. The interior rearview mirror assembly includes a display for displaying images captured by the cameras. The image processor, responsive to receiving the aggregated image data transferred from the multiplexor, displays at the video display video images derived at least in part from the aggregated image data.

### CROSS REFERENCE TO RELATED APPLICATIONS

The present application claims the filing benefits of U.S. provisional application Ser. No. 63/580,002, filed Sep. 1, 2023, and U.S. provisional application Ser. No. 63/513,151, filed Jul. 12, 2023, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

A vehicular vision system includes a plurality of cameras disposed at a vehicle equipped with the vehicular vision system. Each camera of the plurality of cameras views exterior of the vehicle. Each camera of the plurality of cameras is operable to capture image data. Each camera of the plurality of cameras includes a CMOS imaging array having at least one million photosensors arranged in rows and columns. The system includes a multiplexor disposed at the equipped vehicle. Image data captured by each camera of the plurality of cameras is transferred to the multiplexor. The multiplexor is operable to aggregate image data captured by each camera of the plurality of cameras into aggregated image data. An interior rearview mirror assembly disposed at the equipped vehicle, and the interior rearview mirror assembly is remote from the multiplexor. The interior rearview mirror assembly includes a mirror head adjustably disposed at a mounting base configured to mount the interior rearview mirror assembly at an interior portion of the equipped vehicle. The mirror head includes a mirror casing and a mirror reflective element. The interior rearview mirror assembly includes an electronic control unit (ECU) with electronic circuitry and associated software. Aggregated image data aggregated by the multiplexor is transferred from the multiplexor to the ECU of the interior rearview mirror assembly. The electronic circuitry of the ECU includes an image processor for processing the transferred aggregated image data. The interior rearview mirror assembly includes a video display that is operable to display video images for viewing by a driver of the vehicle. The vehicular vision system, via processing at the ECU of aggregated image data aggregated by the multiplexor and transferred to the ECU, displays at the video display video images derived at least in part from the aggregated image data.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a block diagram of a vehicular vision system with image signal processors (ISPs) disposed at a remote engine control unit (ECU);

FIG. 3 is a block diagram of a vehicular vision system with an ISP disposed at an interior rearview mirror assembly;

FIG. 4 is a block diagram of an ECU of the vehicular vision system of FIG. 3;

FIG. 5 is a block diagram of the interior rearview mirror assembly of FIG. 3

FIG. 6 is a top view of a vehicle equipped with cameras having a dynamic field of view;

FIG. 7 is a top view of a vehicle equipped with a display having dynamic mode configuration;

FIG. 8 is a view of an interior rearview mirror dynamically adjusting modes to adjust a field of view of displayed images;

FIG. 9 is a perspective view of an interior rearview mirror assembly without scale adjustments; and

FIG. 10 is a top view of a vehicle equipped with a display having a field of view scale adjustment based on positions of cameras.

### DESCRIPTION OF THE PREFERRED EMBODIMENTS

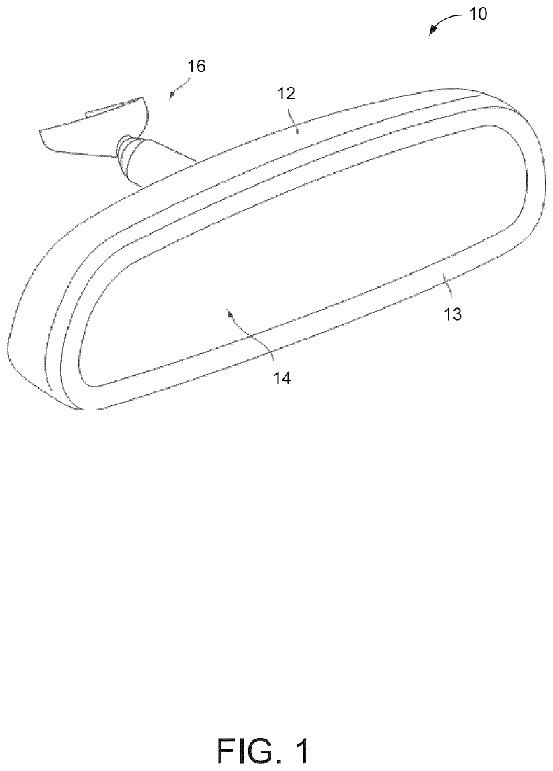

Referring now to the drawings and the illustrative embodiments depicted therein, an interior rearview mirror assembly 10 for a vehicle includes a casing 12, a bezel 13, and a reflective element 14 positioned at a front portion of the casing 12 (FIG. 1) and surrounded by the bezel 13. In the illustrated embodiment, mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 16. The mirror reflective element may include a variable reflectance mirror reflective element that varies its reflectance responsive to electrical current applied to conductive coatings or layers of the reflective element.

The mirror assembly 10 is associated with a vehicular vision system and/or driver monitoring system (DMS), and/or an occupant monitoring system (OMS) that operates to capture images exterior and/or interior of the vehicle. The vision system includes an image processor or image processing system that is operable to receive image data from one or more cameras and provide an output to a display device for displaying images representative of the captured image data. The vision system provides a display disposed at the interior rearview mirror assembly 10, such as a rearview display or a top down or bird's eye or surround view display (or any other composite view) or the like.

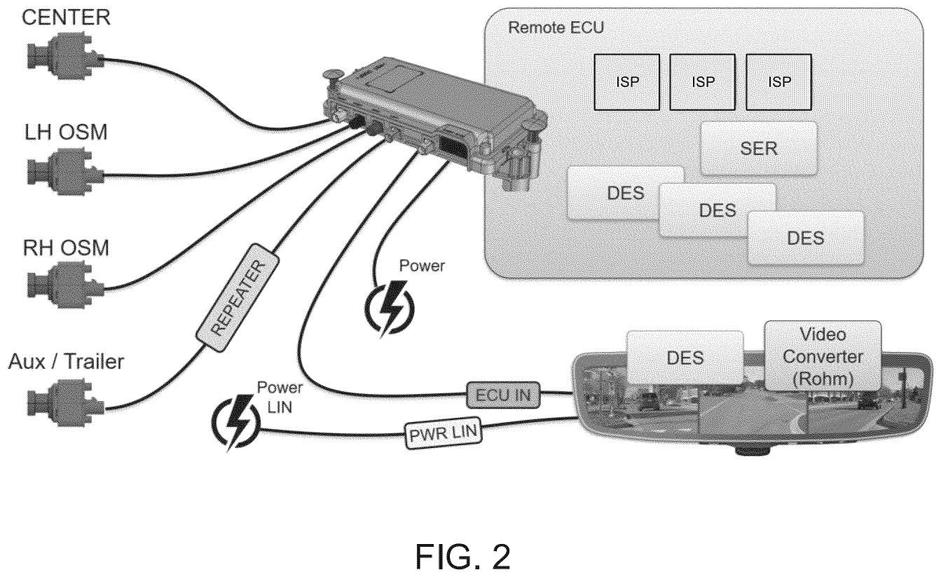

Referring now to FIG. 2, in some multi-camera vision systems, a remote engine control unit (ECU) receives image data captured by one or more cameras (such as a rearward viewing imaging sensor or camera, a forward viewing camera at the front and/or at the windshield of the vehicle, a sideward/rearward viewing camera at respective sides of the vehicle (e.g., disposed at side mirrors of the vehicle), a trailer camera, etc.). Here, the ECU is remote (i.e., is independent and spaced apart from) the displays/rearview mirror assembly. The remote ECU processes the image data using multiple image system processors (ISPs) and aggregates the image data/video data and sends the aggregated and processed data to the interior rearview mirror (e.g., via a cable or wire) which may display the aggregated image data at one or more displays disposed within or at the rearview mirror. The displays may display the image data captured by one or more of the cameras. For example, the display may display image data captured by a rear viewing camera while the vehicle performs a reversing maneuver or the display may display a surround view image when the vehicle performs a parking maneuver.

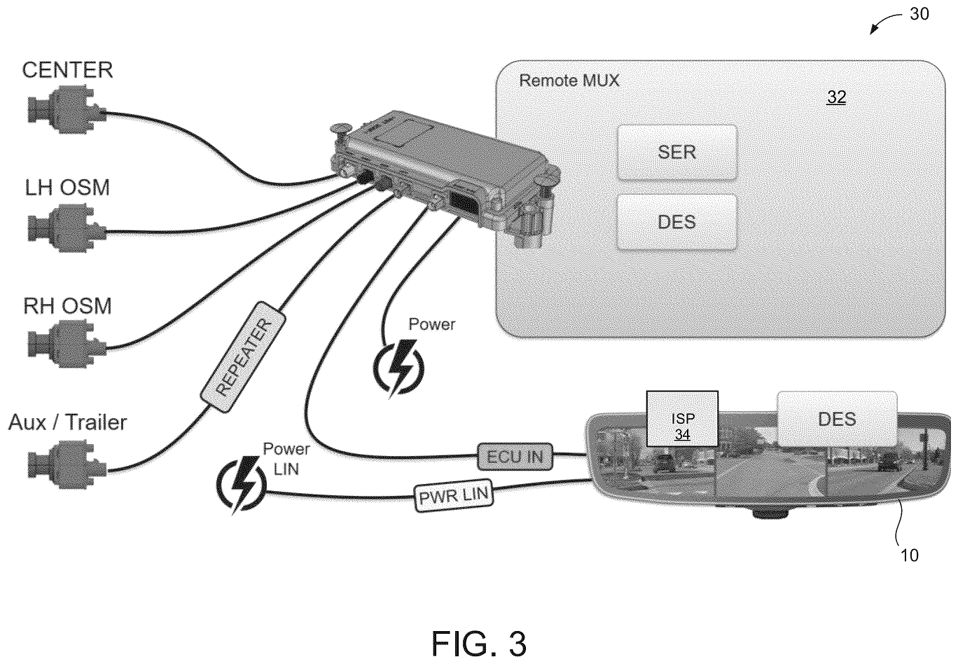

Referring now to FIG. 3, implementations herein include a vision system 30 that includes a remote multiplexor 32, which may be, for example, an ECU without an ISP (or otherwise does not use local resources to process the image data), which lowers the cost and complexity of the remote multiplexor 32. The remote multiplexor 32 aggregates (e.g., merges or combines) the image data/video data from each of the cameras connected to the remote multiplexor 32 (e.g., a rearward viewing imaging sensor or camera, a forward viewing camera, one or more sideward/rearward viewing cameras at respective sides of the vehicle, a trailer camera, etc.) and transmits or transfers the aggregated image data to the interior rearview mirror assembly 10. Optionally, the remote multiplexor 32 transmits or sends or transfers the aggregated image data to one or more other displays (e.g., a center console display, a head up display, etc.). The interior rearview mirror assembly 10 includes an ISP 34 (such as at an ECU or the like) that processes the aggregated image data at the interior rearview mirror assembly 10 for display at one or more displays within the vehicle (e.g., disposed at the interior rearview mirror assembly, at a console of the vehicle, at a dash of the vehicle, etc.). By including the ISP 34 at the interior rearview mirror assembly 10 instead of at a remote ECU (as shown in FIG. 2), the vision system 30 is more modular and allows for the interior rearview mirror assembly to support a number of different visions systems, such as systems with center high mounted stop lamp (CHMSL) cameras, trailer cameras, driver monitoring system cameras, occupant monitoring system cameras, etc. The remote multiplexor 32 (which is lower cost due to the lack of ISPs or other image processing capabilities) allows the interior rearview mirror assembly 10 to accommodate or work with any number of cameras (e.g., one camera systems, two camera systems, four camera systems, six cameras, etc.) without having to change the rearview mirror assembly. Thus, the vision system 30 may include a single printed circuit board (PCB) for the interior rearview mirror assembly 10 with a single connector that would work across a large number of variants (i.e., different camera configurations) to support different vehicles and system needs.

Optionally, one or more cameras may transmit image data directly to the interior rearview mirror assembly while two or more other cameras send image data to the remote multiplexor 32. For example, a camera for a DMS or an OMS may be integrated into the interior rearview mirror assembly and may provide image data directly to the image processor without first being aggregated by the remote multiplexor 32 (e.g., due to the proximity of the camera to the ISP).

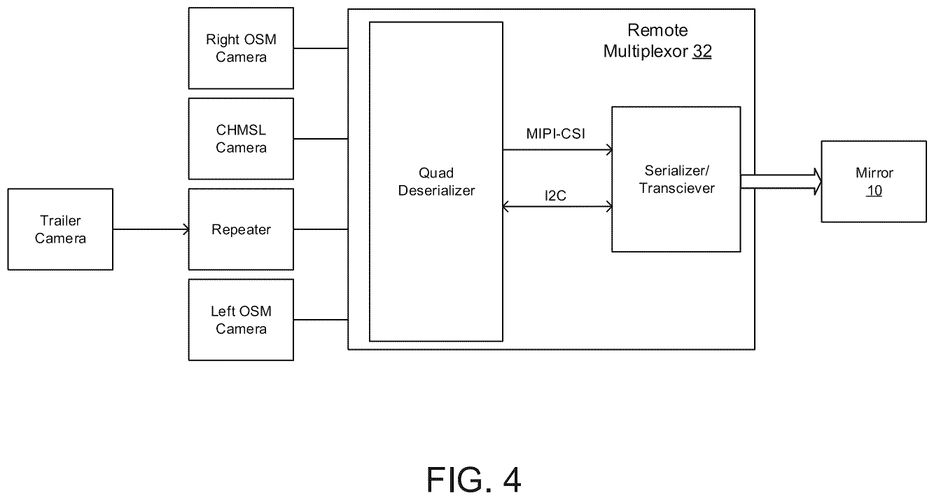

Referring now to FIG. 4, the remote multiplexor 32 receives image data or video data from any number of cameras. In this example, the remote multiplexor 32 receives image data from a right surround view camera (e.g., disposed at a right side mirror of the vehicle), a left surround view camera (e.g., disposed at a left side mirror of the vehicle), a CHMSL camera, and a trailer camera (via a repeater). Optionally, the remote multiplexor 32 includes one or more deserializers. The remote multiplexor may include a separate deserializer for each camera or, as in this example, a single deserializer for all of the cameras (e.g., a dual deserializer, a quad deserializer, etc.). The remote multiplexor 32 may deserialize the image data received from the cameras, aggregate the deserialized image data, and then serialize the aggregated data using a serializer/transceiver. The deserializer may communicate with the serializer via, for example, a Mobile Industry Processor Interface Camera Serial Interface (MIPI-CSI) and/or an inter-integrated circuit (I2C) interface. The serializer sends the aggregated and serialized image data to the interior rearview mirror assembly 10. The remote multiplexor 32 may be disposed at any appropriate location within the vehicle remote from the interior rearview mirror assembly. For example, the remote multiplexor 32 may be disposed at a location centralized to the cameras, at a head unit of the vehicle, at a front camera module (FCM) of the vehicle, etc.

For example, one of the cameras may be a “smart” camera or primary camera that incorporates the multiplexor 32. Such a smart camera (e.g., a forward-viewing camera disposed at the in-cabin side of the windshield of the vehicle and viewing forward of the vehicle through the windshield) receives and aggregates the image data from other (secondary) cameras in the system (e.g., surround vision cameras including the rear backup camera, sideward viewing cameras, such as disposed at respective exterior rearview mirror assemblies of the vehicle, and a forward viewing camera disposed at a front bumper or grille of the vehicle). The smart camera may transfer the aggregated image data to an ECU or other image processor (such as at the interior rearview mirror assembly or at a center console or elsewhere in the vehicle) for display at one or more displays. Alternatively, the smart camera may include the image processor and process the aggregated image data locally.

The remote multiplexor 32 may communicate with the interior rearview mirror assembly 10 using any number of means, such as via Ethernet, via media oriented systems transport (MOST), via fiber-optics, or via various wireless technologies (e.g., a point-to-point wireless solution, WIFI, BLUETOOTH, etc.). The system may utilize aspects of the systems described in U.S. Pat. Nos. 10,694,150; 10,637,229; 10,567,705; 10,452,076; 10,298,823; 10,089,537; 10,071,687; 10,046,706; 9,900,490 and/or 9,609,757, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

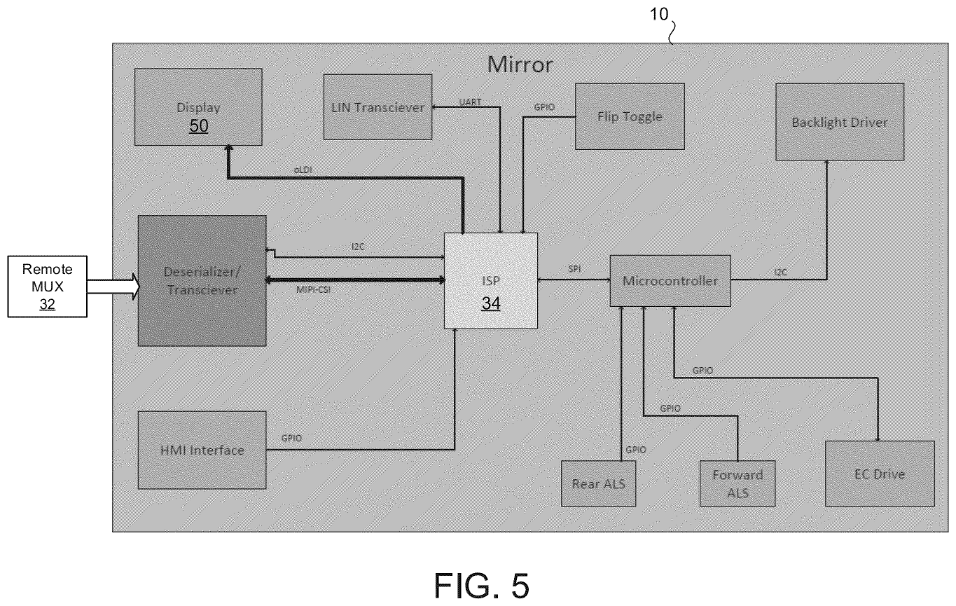

Referring now to FIG. 5, the interior rearview mirror assembly 10 receives the aggregated and serialized image data from the remote multiplexor 32. The interior rearview mirror assembly 10 may include a number of components or modules. Here, the interior rearview mirror assembly 10 includes a deserializer/transceiver to receive and deserialize the aggregated image data from the remote multiplexor 32 which communicates with an ISP 34 (e.g., via I2C and/or MIPI-CSI). The ISP 34 processes the aggregated image data (e.g., to generate one or more views such as virtual views, surround views, etc., for display or to generate overlays, dewarp the image data, etc.). The ISP 34 may transmit the processed image data or video data to a display 50 to allow an occupant of the vehicle to view the processed image data. Optionally, the interior rearview mirror assembly 10 includes a human-machine interface (HMI) to allow an occupant of the vehicle to provide user input to the interior rearview mirror assembly 10 (e.g., to select a particular view, to adjust a field of view, to enable/disable the features, etc.). The interior rearview mirror assembly 10 may also include a microcontroller, a backlight driver, an electrochromic driver, and other components to provide automatic dimming to reduce glare.

The display 50 may include a backlight that emits light at a variable intensity to adapt to ambient light conditions. In some examples, to reduce power consumption, the ISP 34 (or other controller or processor) adjusts an intensity of the backlight based on a gaze direction of an occupant of the vehicle (e.g., the driver of the vehicle). For example, the ISP 34 may reduce the intensity of the backlight when the ISP 34 determines that the driver's gaze is not directed toward the display 50 in order to reduce power consumption. When the ISP 34 determines that the driver's gaze is moving toward or is directed toward the display 50, the ISP 34 may quickly and smoothly increase the intensity of the backlight for comfortable viewing by the driver. The ISP 34 may determine the gaze direction of the driver or other occupant using a driver monitoring camera or an occupant monitoring camera disposed at, for example, the interior rearview mirror assembly 10. In other examples, the camera is disposed at another location within the vehicle, such as at a dashboard, at a console, at a headliner, etc.

The camera may provide gaze direction information to the ISP 34 via any number of communication protocols, such as CAN, Ethernet, USB, etc. The driver or other occupant of the vehicle may enable, disable, or otherwise control/configure the backlight dimming. For example, the driver may enable or disable the backlight power consumption feature via a user menu at the interior rearview mirror assembly 10 or at another display or console within the vehicle. The ISP 34 may ensure that the backlight remains at a threshold minimum intensity to comply with any necessary regulations or standards (such as Automotive Safety Integrity Level (ASIL) and ECE-R46 regulations or standards).

In some examples, one or more cameras of the vehicle include an integrated mechanical cleaning solution. For example, one or more cameras of the vehicle include one or more piezoelectric actuators for a cover glass of the camera, a lens of the camera, and/or a body of the camera. Actuator motion may be synchronized to the blanking interval of the imager (i.e., synced with the exposure time of the imager). That is, the actuator motion may only be enabled during periods when the imager is not capturing image data to prevent focus shift or blurry capture in case the lens moves relative to the imager. Optionally, the piezoelectric actuator actuates the camera/lens/cover at greater than a threshold frequency to ensure completion during the imager blanking time. For example, the piezo excitation frequency may be greater than 4 kHz. In some examples, the piezo excitation frequency is greater than 4 kHz and less than 6 kHz. The actuator may be enabled at regular intervals and/or in response to detecting/determining an occlusion or other deficiency in captured image data.

The piezoelectric actuator (e.g., a ceramic element of the piezoelectric actuator) may electrically connect to the camera and/or driver module in a number of ways, such as via wires, a flexible polyimide strip, and/or pins (such as pogo pins). Optionally, circuitry required for the piezoelectric actuators may be embedded within the camera (i.e., within the housing or casing of the camera), such as at a LIN or CAN controller in the mirror head. In other examples, the circuitry is embedded within an occupant monitoring system (OSM) control module or as a sealed module within an OSM head unit. The piezo driver circuitry may be integrated into the housing or frame of the camera for cover glass.

The camera assembly for one or more cameras of the vehicle may include a flexible mounting to allow the piezo element(s) to vibrate the entire camera assembly as opposed to, for example, only the cover lens. For example, the piezo elements may include external springs to allow vibrations of equipment up to 2 kg. The flexible mounting may have a resonant frequency greater than a threshold frequency to avoid other vehicle vibration inputs. For example, the flexible mounting has a resonant frequency between 4 kHz and 6 kHz to avoid conflict with vehicle vibration inputs below 1 kHz.

The piezo element may be bonded/stacked with a positive temperature coefficient (PTC) thermal element that is powered and/or controlled via the same wires. In this setup, the PTC thermal element may be powered via direct current (DC) while the piezo element may be powered via alternating current (AC). A spring terminal or pogo terminal or the like may couple the piezo element and the PTC thermal element. Alternatively, the PTC element and the piezo element may be directly soldered together or be joined via a conductive epoxy.

The ISP 34 may enable or actuate the piezo element automatically upon detection of a blockage/occlusion of the field of view of the camera (e.g., via image processing techniques used on image data captured by the camera), automatically upon determination of environmental conditions surrounding the vehicle (e.g., snow, rain, sleet, etc.), upon actuation of a user input, and/or at regular intervals (e.g., when the vehicle is first started, once every minute, once every hour, etc.).

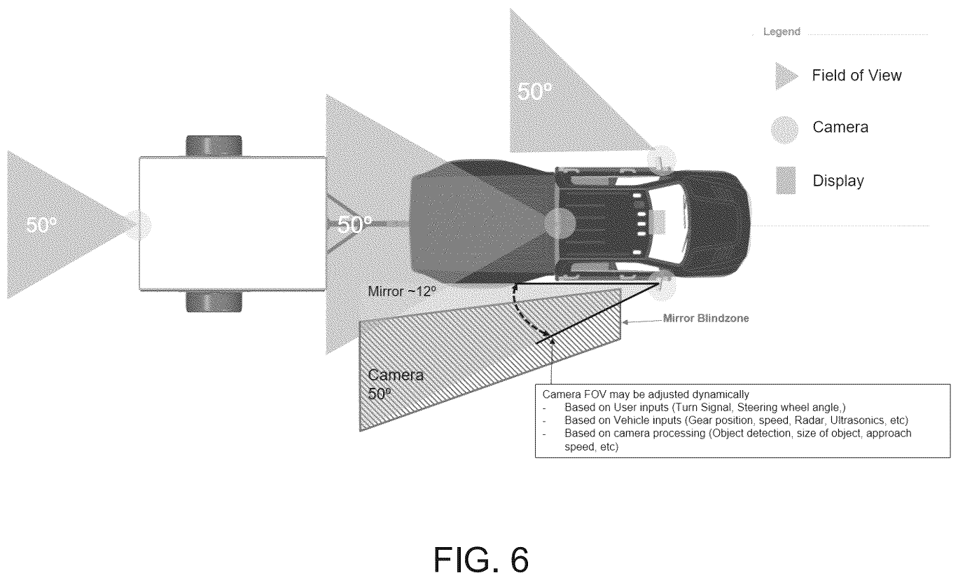

Referring now to FIG. 6, in some examples, the field of views of one or more cameras of the vehicle may be dynamically adjusted based on user inputs (e.g., turn signals, steering wheel angle, throttle/brake control, etc.), based on vehicle inputs (e.g., gear position, vehicle speed, radar data, ultrasonics data, etc.), and/or based on image data captured by the one or more cameras (e.g., object detection data, such as the size of objects, the speed of objects, the trajectory of objects, etc.). The field of view may be dynamically adjusted based on, for example, blind zones or blind spots of the vehicle mirrors (i.e., to expand the driver's field of view beyond what the mirrors provide). For example, when the user actuates the left turn signal of the vehicle, the field of view of one or more cameras may be adjusted to increase the field of view of the one or more cameras to the left of the vehicle. As another example, the field of view of a camera may be dynamically adjusted to include an object detected by another sensor (e.g., a radar sensor). The field of view may be dynamically adjusted using image processing techniques on a wide-angle view camera (i.e., by selecting a subset of the image data to display) and/or by adjusting orientation of the cameras.

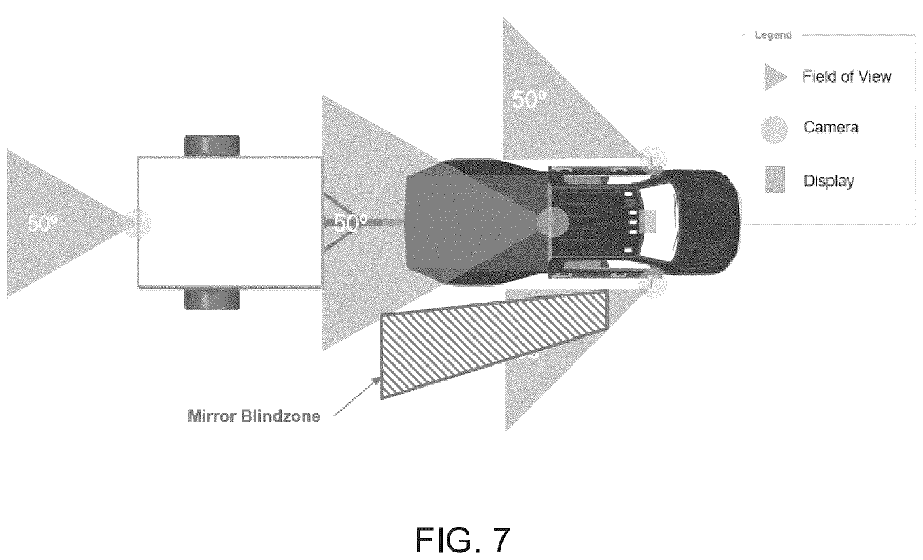

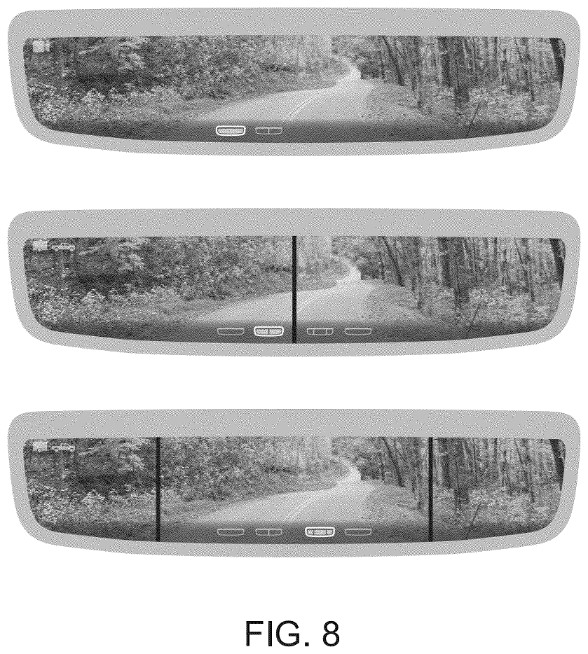

Referring now to FIGS. 7 and 8, in some examples, the display 50 (FIG. 5) of the interior rearview mirror assembly 10 may be dynamically adjusted through a plurality of different modes. For example, the mode may be dynamically adjusted based on, for example, blind zones or spots of the vehicle mirrors (i.e., to expand the driver's field of view beyond what the mirrors provide) (FIG. 7). As shown in FIG. 8, each mode may adjust an amount of a field of view of each camera that is displayed on the display 50. For example, in one mode, only a field of view of a rearview camera is displayed, while in another mode, the field of view of the rearview camera is supplemented with the field of view of one or both side mirror cameras. That is, each mode may display different portions of the field of views of different cameras. The views may be dynamic based on inputs from the driver or one or more sensors of the vehicle. For example, if the driver engages the left turn signal, the display may dynamically switch modes to add at least a portion of a field of view of a camera viewing to the left of the vehicle (and in turn reducing or replacing a field of view being previously displayed) or expand an already displayed field of view to include additional area to the left of the vehicle. The display system may utilize aspects of the systems described in International Publication No. WO 2022/150826, which is hereby incorporated herein by reference in its entirety.

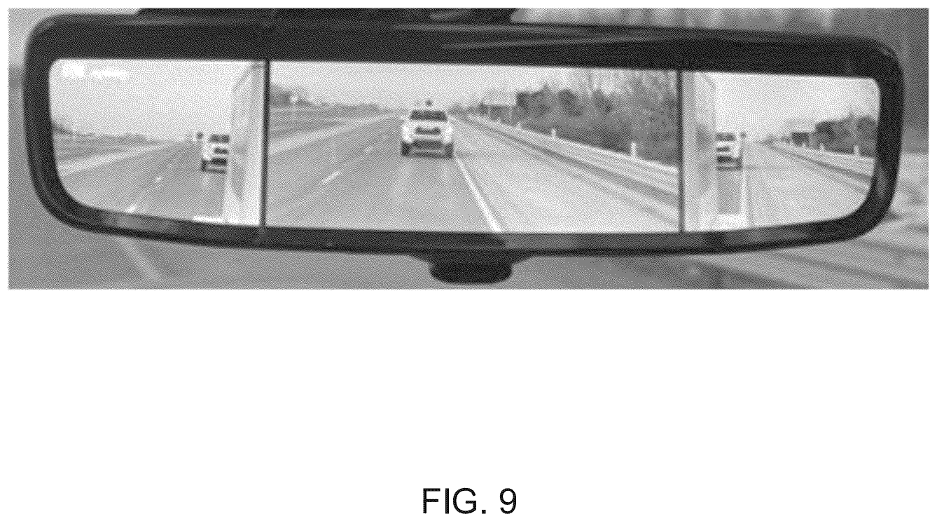

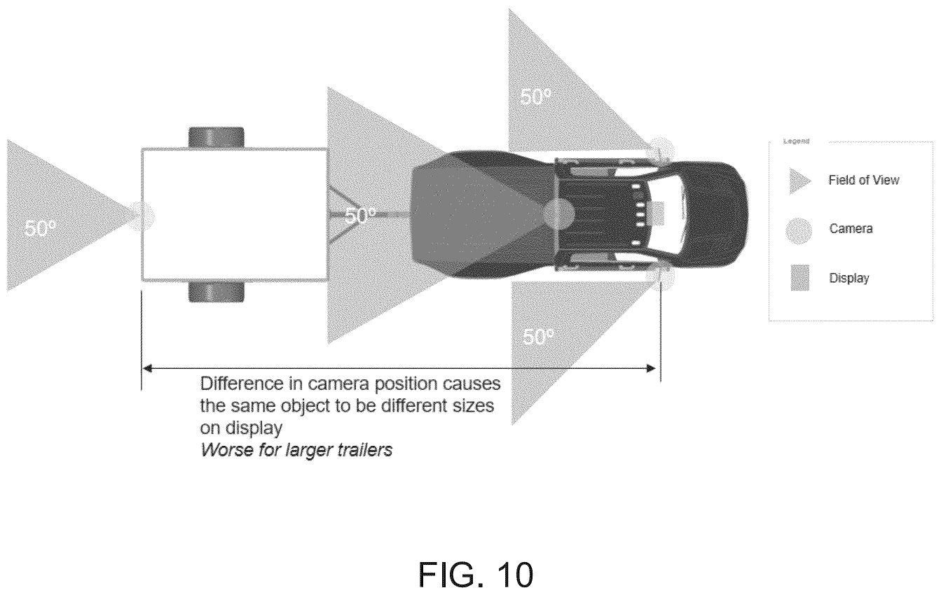

Referring now to FIGS. 9 and 10, optionally, displayed images on the display 50 are scaled when the vehicle is towing a trailer. As shown in FIG. 9, because of differences in camera positions (e.g., the trailer camera at the rear of trailer is behind the side view mirror cameras), objects captured by different cameras appear to be different sizes. In this example, a truck following the equipped vehicle appears larger in the center image that is captured by a rear trailer camera than it does on the side images that are captured by side mirror cameras because the rear trailer camera is closer to the truck than the side mirror cameras. As shown in FIG. 10, in these scenarios, the images captured by one or more cameras are scaled so that objects captured by different cameras appear to be the same size. For example, image data captured by the trailer camera may be scaled down (i.e., decreased in size) and/or image data captured by the side mirror cameras may be scaled up (i.e., increased in size). Thus, when the cameras observe objects at different sizes (such as when towing a trailer), the system may adjust the displayed images to ensure uniformity in object sizes, compensating for camera variations. This enhances the driver's perception and provides a more accurate representation of the surroundings. The compensation may be automatic or based on user input.

The ISP 34 may detect or determine a difference in size between an object captured by multiple cameras automatically. The adjustment made by the ISP 40 based on the determined difference in size may be configurable (e.g., based on user preferences) and/or based on the determined difference in size. Optionally, the scaling may be based on a distance between the cameras, which may be configured by a manufacturer of the vehicle and/or a user of the vehicle.

The interior mirror assembly may include a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855;755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736 and/or US-2010-0097469, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704; US-2009-0244361 and/or US-2010-0214791, and/or International Publication Nos. WO 2009/046268 and/or WO 2009/036176, which are all hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EYEQ™ image processing chip available from Mobileye Vision Technologies Ltd. of Jerusalem, Israel, and such as an image processor of the types described in U.S. Pat. No. 9,126,525, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

Optionally, the DMS camera may be used to detect ambient light and/or glare light (emanating from headlamps of a trailing vehicle) for use in providing auto-dimming of the EC mirror reflective element (and/or for use in adjusting intensity of a display screen or a light emitter). The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Pat. Nos. 11,780,372; 11,242,008; 10,967,796 and/or 10,948,798, and/or U.S. Publication No. US-2024-0064274, and/or U.S. provisional application Ser. No. 63/656,731, filed Jun. 6, 2024, and/or U.S. provisional application Ser. No. 63/588,347, filed Oct. 6, 2023, which are all hereby incorporated herein by reference in their entireties.

Optionally, image data captured by a rearward-viewing camera (e.g., a rear backup camera or other rearward-viewing camera disposed at a rear portion of the vehicle, or a driver or occupant or cabin monitoring camera that views rearward within the cabin of the vehicle and rearward of the vehicle via a rear window of the vehicle) may be image processed to determine ambient light (and/or glare light) present at the vehicle. Thus, for example, during nighttime driving, image processing of captured image data can be used to appropriately control dimming of the mirror reflective element or the intensity of backlighting of a video display screen to be appropriate for nighttime driving. Also, for example, during high ambient driving, the backlighting is increased so the displayed images are not washed out. The intelligent/automatic mirror dimming functions and/or video display screen dimming functions may utilize aspects of the systems described in U.S. Pat. Nos. 11,780,372; 11,242,008; 10,967,796 and/or 10,948,798, and/or U.S. Publication No. US-2024-0064274, and/or U.S. provisional application Ser. No. 63/656,731, filed Jun. 6, 2024, and/or U.S. provisional application Ser. No. 63/588,347, filed Oct. 6, 2023, which are all hereby incorporated herein by reference in their entireties.

For example, the system or controller may adjust or control dimming of an electrochromic mirror reflective element, or dimming of a liquid crystal mirror reflective element, or dimming or intensity of a video display screen (at the mirror or at the console of the vehicle), or dimming or intensity of interior cabin lighting (such as lights and icons at an instrument panel of the vehicle), etc.

Optionally, the system, via processing of image data captured by the DMS camera viewing the driver's eyes, may determine glare light by detecting reflection of glare light off of the driver's eyes (or off of eyeglasses if worn by the driver). For example, glare light emanating from a rearward approaching vehicle behind the equipped vehicle may reflect off the mirror reflector of the mirror reflective element of the interior rearview mirror assembly and reflect toward the driver's eyes (or eyeglasses) and reflect off the driver's eyes (or eyeglasses). The system may detect the glare light reflections at the driver's eyes (or eyeglasses) and may control dimming of the mirror reflective element and/or control of the video display screen accordingly. The system thus may determine glare light emanating from rearward of the vehicle by processing image data captured by the driver monitoring camera, particularly by processing a portion of the captured image data that is representative of the driver's eyes, thereby avoiding having to process larger amounts of image data representative of a view rearward of the vehicle.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,582,425; 11,518,401; 10,958,830; 10,065,574; 10,017,114; 9,405,120 and/or 7,914,187, and/or U.S. Publication Nos. US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. provisional application Ser. No. 63/641,574, filed May 2, 2024 (Attorney Docket DON01 P5156), and/or International Publication Nos. WO 2023/220222; WO 2022/241423; WO 2022/187805 and/or WO 2023/034956, which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

The mirror assembly may receive image data captured by a plurality of cameras of the vehicle, such as by a plurality of surround view system (SVS) cameras and a plurality of camera monitoring system (CMS) cameras and optionally one or more driver monitoring system (DMS) cameras. The image processor of the mirror assembly may comprise a central or single image processor that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2021-0155167 and/or US-2019-0118717, and/or International Publication No. WO 2022/150826, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular vision system, the vehicular vision system comprising:
a plurality of cameras disposed at a vehicle equipped with the vehicular vision system, each camera of the plurality of cameras viewing exterior of the vehicle;
wherein each camera of the plurality of cameras is operable to capture image data;
wherein each camera of the plurality of cameras comprises a CMOS imaging array having at least one million photosensors arranged in rows and columns;
a multiplexor disposed at the equipped vehicle;
wherein image data captured by each camera of the plurality of cameras is transferred to the multiplexor;
wherein the multiplexor is operable to aggregate image data captured by each camera of the plurality of cameras into aggregated image data;
an interior rearview mirror assembly disposed at the equipped vehicle, wherein the interior rearview mirror assembly is remote from the multiplexor;
wherein the interior rearview mirror assembly comprises a mirror head adjustably disposed at a mounting base configured to mount the interior rearview mirror assembly at an interior portion of the equipped vehicle, and wherein the mirror head comprises a mirror casing and a mirror reflective element;
wherein the interior rearview mirror assembly comprises an electronic control unit (ECU) comprising electronic circuitry and associated software;
wherein aggregated image data aggregated by the multiplexor is transferred from the multiplexor to the ECU of the interior rearview mirror assembly;
wherein the electronic circuitry of the ECU comprises an image processor for processing the transferred aggregated image data;
wherein the interior rearview mirror assembly comprises a video display that is operable to display video images for viewing by a driver of the vehicle; and
wherein the vehicular vision system, via processing at the ECU of aggregated image data aggregated by the multiplexor and transferred to the ECU, displays at the video display video images derived at least in part from the aggregated image data.

2. The vehicular vision system of claim 1, wherein the multiplexor comprises a deserializer, and wherein the multiplexor deserializes the image data from each camera of the plurality of cameras prior to aggregating the image data from each camera of the plurality of cameras.

3. The vehicular vision system of claim 2, wherein the multiplexor comprises a serializer, and wherein the multiplexor serializes the aggregated image data prior to transferring the aggregated image data to the ECU.

4. The vehicular vision system of claim 1, wherein the plurality of cameras comprises two or more selected from the group consisting of (i) a forward viewing camera, (ii) a sideward viewing camera, (iii) a rearward viewing camera, (iv) a center high mounted stop lamp camera, (v) a trailer camera, (vi) a driver monitoring camera and (vii) an occupant monitoring camera.

5. The vehicular vision system of claim 1, wherein the transferred aggregated image data is serialized, and wherein the interior rearview mirror assembly comprises a deserializer that deserializes the aggregated image data transferred from the multiplexor.

6. The vehicular vision system of claim 1, wherein the aggregated image data is digitized and transferred from the multiplexor as digital aggregated image data.

7. The vehicular vision system of claim 1, wherein the plurality of cameras comprises four cameras.

8. The vehicular vision system of claim 1, wherein the multiplexor transfers the aggregated image data to the ECU using an Ethernet protocol.

9. The vehicular vision system of claim 1, wherein the multiplexor transfers the aggregated image data to the ECU via wireless communication.

10. The vehicular vision system of claim 1, wherein the vehicular vision system displays bird's eye view video images at the video display.

11. The vehicular vision system of claim 1, wherein the video display comprises a backlight, and wherein intensity of light emitted by the backlight, when electrically operated to emit light, is based on a gaze direction of the driver of the equipped vehicle.

12. The vehicular vision system of claim 11, wherein intensity of light emitted by the backlight is increased when the gaze direction of the driver moves toward the interior rearview mirror assembly, and wherein intensity of light emitted by the backlight is decreased when the gaze direction of the driver moves away from the interior rearview mirror assembly.

13. The vehicular vision system of claim 1, wherein at least one camera of the plurality of cameras comprises a piezoelectric actuator, and wherein actuation of the piezoelectric actuator vibrates at least a portion of the at least one camera to clean the at least one camera.

14. The vehicular vision system of claim 13, wherein actuation of the piezoelectric actuator vibrates at least one selected from the group consisting of (i) a glass cover of the camera, (ii) a lens of the camera and (iii) a housing of the camera.

15. The vehicular vision system of claim 13, wherein the piezoelectric actuator vibrates the at least the portion of the at least one camera at a frequency greater than 1 kHz.

16. The vehicular vision system of claim 1, wherein the vehicular vision system adjusts a field of view of at least one camera of the plurality of cameras.

17. The vehicular vision system of claim 16, wherein the vehicular vision system adjusts the field of view of the at least one camera of the plurality of cameras based on at least one selected from the group consisting of (i) a user input, (ii) a vehicle input and (iii) image processing of image data captured by the at least one camera of the plurality of cameras.

18. The vehicular vision system of claim 1, wherein the vehicular vision system adjusts a display mode of the video display based on at least one selected from the group consisting of (i) a user input, (ii) a vehicle input and (iii) image processing of image data captured by at least one camera of the plurality of cameras.

19. The vehicular vision system of claim 1, wherein the vehicular vision system adjusts a scale of image data captured by a first camera of the plurality of cameras based on a position of the first camera of the plurality of cameras relative to a second camera of the plurality of cameras.

20. The vehicular vision system of claim 1, wherein the vehicular vision system adjusts a scale of image data captured by a first camera of the plurality of cameras to adjust a size of a detected object captured by the image data of the first camera to be the same size as a size of the detected object captured by image data of a second camera of the plurality of cameras.

21. A vehicular vision system, the vehicular vision system comprising:
a plurality of cameras disposed at a vehicle equipped with the vehicular vision system, each camera of the plurality of cameras viewing exterior of the vehicle;
wherein each camera of the plurality of cameras is operable to capture image data;
wherein each camera of the plurality of cameras comprises a CMOS imaging array having at least one million photosensors arranged in rows and columns;
a multiplexor disposed at the equipped vehicle;
wherein image data captured by each camera of the plurality of cameras is transferred to the multiplexor;
wherein the multiplexor is operable to (i) deserialize image data captured by each camera of the plurality of cameras, (ii) aggregate the deserialized image data into aggregated image data and (iii) serialize the aggregated image data;
an interior rearview mirror assembly disposed at the equipped vehicle, wherein the interior rearview mirror assembly is remote from the multiplexor;
wherein the interior rearview mirror assembly comprises a mirror head adjustably disposed at a mounting base configured to mount the interior rearview mirror assembly at an interior portion of the equipped vehicle, and wherein the mirror head comprises a mirror casing and a mirror reflective element;
wherein the interior rearview mirror assembly comprises an electronic control unit (ECU) comprising electronic circuitry and associated software;
wherein the interior rearview mirror assembly comprises a deserializer;
wherein serialized aggregated image data aggregated by the multiplexor is transferred from the multiplexor to the deserializer of the interior rearview mirror assembly;
wherein the deserializer is operable to deserialize the serialized aggregated image data that is transferred from the multiplexor to the deserializer of the interior rearview mirror assembly;
wherein the electronic circuitry of the ECU comprises an image processor for processing the deserialized aggregated image data;
wherein the interior rearview mirror assembly comprises a video display that is operable to display video images for viewing by a driver of the vehicle; and
wherein the vehicular vision system, via processing at the ECU of the deserialized aggregated image data, displays at the video display video images derived at least in part from the deserialized aggregated image data.

22. The vehicular vision system of claim 21, wherein the plurality of cameras comprises two or more selected from the group consisting of (i) a forward viewing camera, (ii) a sideward viewing camera, (iii) a rearward viewing camera, (iv) a center high mounted stop lamp camera, (v) a trailer camera, (vi) a driver monitoring camera and (vii) an occupant monitoring camera.

23. The vehicular vision system of claim 21, wherein the multiplexor transfers the serialized aggregated image data to the deserializer of the interior rearview mirror assembly using an Ethernet protocol.

24. The vehicular vision system of claim 21, wherein the vehicular vision system displays bird's eye view video images at the video display.

25. The vehicular vision system of claim 21, wherein the video display comprises a backlight, and wherein intensity of light emitted by the backlight, when electrically operated to emit light, is based on a gaze direction of the driver of the equipped vehicle.

26. The vehicular vision system of claim 25, wherein intensity of light emitted by the backlight is increased when the gaze direction of the driver moves toward the interior rearview mirror assembly, and wherein intensity of light emitted by the backlight is decreased when the gaze direction of the driver moves away from the interior rearview mirror assembly.

27. A vehicular vision system, the vehicular vision system comprising:
a plurality of cameras disposed at a vehicle equipped with the vehicular vision system, each camera of the plurality of cameras viewing exterior of the vehicle;
wherein each camera of the plurality of cameras is operable to capture image data;
wherein each camera of the plurality of cameras comprises a CMOS imaging array having at least one million photosensors arranged in rows and columns;
a multiplexor disposed at the equipped vehicle;
wherein image data captured by each camera of the plurality of cameras is transferred to the multiplexor;
wherein the multiplexor is operable to aggregate image data captured by each camera of the plurality of cameras into aggregated image data;
an interior rearview mirror assembly disposed at the equipped vehicle, wherein the interior rearview mirror assembly is remote from the multiplexor;
wherein the interior rearview mirror assembly comprises a mirror head adjustably disposed at a mounting base configured to mount the interior rearview mirror assembly at an interior portion of the equipped vehicle, and wherein the mirror head comprises a mirror casing and a mirror reflective element;
wherein the interior rearview mirror assembly comprises an electronic control unit (ECU) comprising electronic circuitry and associated software;
wherein aggregated image data aggregated by the multiplexor is transferred from the multiplexor to the ECU of the interior rearview mirror assembly;
wherein the electronic circuitry of the ECU comprises an image processor for processing the transferred aggregated image data;
wherein the interior rearview mirror assembly comprises a video display that is operable to display video images for viewing by a driver of the vehicle;
wherein the vehicular vision system, via processing at the ECU of aggregated image data aggregated by the multiplexor and transferred to the ECU, displays at the video display video images derived at least in part from the aggregated image data;
wherein the vehicular vision system adjusts the field of view of at least one camera of the plurality of cameras based on at least one selected from the group consisting of (i) a user input, (ii) a vehicle input and (iii) image processing of image data captured by the at least one camera of the plurality of cameras; and
wherein the vehicular vision system adjusts a scale of image data captured by a first camera of the plurality of cameras based on a position of the first camera of the plurality of cameras relative to a second camera of the plurality of cameras.

28. The vehicular vision system of claim 27, wherein the vehicular vision system adjusts a display mode of the video display based on at least one selected from the group consisting of (i) a second user input, (ii) a second vehicle input and (iii) image processing of image data captured by at least one camera of the plurality of cameras.

29. The vehicular vision system of claim 27, wherein the vehicular vision system adjusts the scale of image data captured by the first camera of the plurality of cameras to adjust a size of a detected object captured by the image data of the first camera to be the same size as a size of the detected object captured by image data of the second camera of the plurality of cameras.

30. The vehicular vision system of claim 27, wherein the plurality of cameras comprises two or more selected from the group consisting of (i) a forward viewing camera, (ii) a sideward viewing camera, (iii) a rearward viewing camera, (iv) a center high mounted stop lamp camera, (v) a trailer camera, (vi) a driver monitoring camera and (vii) an occupant monitoring camera.
